(19) United States
(12) Patent Application Publication
(10) Pub. No.: US 2021/0226448 A1
(43) Pub. Date: Jul. 22, 2021

(54) ELECTRICAL GRID CONTROL SYSTEM AND METHOD

(71) Applicants: EATON INTELLIGENT POWER LIMITED, DUBLIN 4 (IE); MASSACHUSETTS INSTITUTE OF TECHNOLOGY, CAMBRIDGE, MA (US)

(72) Inventors: Ahmadreza Malekpour, Watertown, MA (US); Jalpa Shah, Woodbury, MN (US); Yigang Wang, Maple Grove, MN (US); Damrongrit Piyabongkarn, Plymouth, MN (US); Anuradha Annaswamy, West Newton, MA (US)

(21) Appl. No.: 15/734,901

(22) PCT Filed: Jun. 3, 2019
(86) PCT No.: PCT/IB2019/000580

§ 371 Date: Dec. 3, 2020

Related U.S. Application Data
(60) Provisional application No. 62/680,194, filed on Jun. 4, 2018.

(51) Int. Cl. H02J 3/16; H02J 3/00; H02J 3/46; G05B 13/02; H02J 3/38

(52) U.S. Cl. CPC H02J 3/16; H02J 3/004; H02J 3/46; H02J 2300/20; H02J 3/381; H02J 3/003; G05B 13/021

(57) ABSTRACT

An electrical grid control system includes a number of load tap changers (2), a number of voltage regulators (4), a number of capacitor banks (6), a number of distributed generators (10), and a centralized control unit (12) structured to generate settings information for the load tap changers (2), the voltage regulators (4), the capacitor banks (6), and the distributed generators (10) based on forecasted data. The distributed generators (10) are structured to use the settings information and a distributed algorithm to control power provisioning from each of the distributed generators (10). The load tap changers (2), the voltage regulators (4), and the capacitor banks (6) are structured to adjust their settings based on the settings information and local voltage measurements.

### BACKGROUND

### Field

The disclosed concept relates to electrical power grid operation and, more particularly, to a layered approach to control the electrical power grids in an efficient and resilient manner.

### Background Information

Electrical power distribution to commercial, industrial, and residential sectors is provided via power distribution grids. The voltage and volt-ampere reactive (VAR) throughout the grid is controlled in order to provide reliable power to the customers. Typically, control of voltage and VAR throughout the grid is achieved through control of various equipment such as load tap changers (LTCs), voltage regulators (VRs), and capacitor banks (CBs).

The electric power grid is transitioning from a system that relies on centralized, polluting sources of power to a sustainable, flexible network that incorporates massive distributed energy resources (DERs) such as small distributed generators (DGs) scattered at various locations on the distribution grid. In addition to reliable delivery of power to its end-user at all times, cyber-physical resilience of distribution grid is a necessary requirement. However, existing power distribution systems were not designed to accommodate high levels of DER penetration while sustaining high levels of reliability, power quality, and/or resilience.

As the complexity of the grid increases, effectively controlling the voltage and VAR (volt/VAR) throughout the grid and ability to withstand high-impact disturbances becomes more difficult. For example, potential localized voltage excursions, limited visibility, fast DG variations, intermittency in renewable power sources, shifting loads, outage management and load restoration, and bidirectional power are examples of issues that can cause difficulty in effective volt/VAR control and resilient operation of the grid.

There is room for improvement in electrical power distribution grid control and resilient operation.

### SUMMARY

These needs and others are met by embodiments of the disclosed concept in which a hierarchical method of controlling an electrical grid includes centralized optimization and distributed control.

In accordance with one aspect of the disclosed concept, an electrical grid control system comprises: a number of LTCs; a number of VRs; a number of CBs; a number of distributed generators; and a centralized control unit structured to generate settings information for the LTCs, the VRs, the CBs, and the distributed generators based on load and generation forecasted data, wherein the distributed generators are structured to use the settings information and a distributed algorithm to provision DGs active and reactive power, and wherein the LTCs, the VRs, and the CBs are structured to adjust their switching operation based on the settings information and local voltage measurements.

In accordance with another aspect of the disclosed concept, A method of controlling an electrical grid comprises: generating settings information for LTCs, VRs, CBs, and distributed generators based on forecasted data; adjusting power provisioning of the distributed generators based on the settings information and a distributed algorithm; and adjusting settings of the load tap changes, VRs, and CBs based on the settings information and local voltage measurements.

In accordance with another aspect of the disclosed concept, an electrical grid control system comprises: a number of LTCs; a number of VRs; a number of CBs; a number of distributed generators; and a centralized control unit structured to generate settings information for the LTCs, the VRs, the CBs, and the distributed generators based on forecasted data, wherein the centralized control unit is structured to control settings of the LTCs, the VRs, and the CBs based on the generated settings information, and wherein the distributed generators are structured to use the settings information and a distributed algorithm to control power provisioning from each of the distributed generators.

In accordance with another aspect of the disclosed concept, a method of controlling an electrical grid comprises: generating settings information for LTCs, VRs, CBs, and distributed generators based on forecasted data; adjusting power provisioning of the distributed generators based on the settings information and a distributed algorithm; and adjusting settings of the load tap changes, VRs, and CBs based on the settings information.

### BRIEF DESCRIPTION OF THE DRAWINGS

A full understanding of the disclosed concept can be gained from the following description of the preferred embodiments when read in conjunction with the accompanying drawings in which:

FIG. 1 is a schematic diagram of an electrical grid in accordance with an example embodiment of the disclosed concept;

FIG. 2 is a conceptual diagram of a hierarchical layered approach to controlling an electrical grid in accordance with an example embodiment of the disclosed concept;

FIG. 3 is a conceptual diagram of a hierarchical layered approach to controlling an electrical grid in accordance with another example embodiment of the disclosed concept;

FIG. 4 is a flowchart of a method of controlling an electrical grid in accordance with an example embodiment of the disclosed concept; and

FIG. 5 is a flowchart of a method of controlling an electrical grid in accordance with another example embodiment of the disclosed concept.

### DESCRIPTION OF THE PREFERRED EMBODIMENTS

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

As employed herein, the term “number” shall mean one or more.

As employed herein, the term “processor” shall mean a programmable analog and/or digital device that can store, retrieve, and process data; a microprocessor; a microcontroller; a microcomputer; a central processing unit; or any suitable processing device or apparatus.

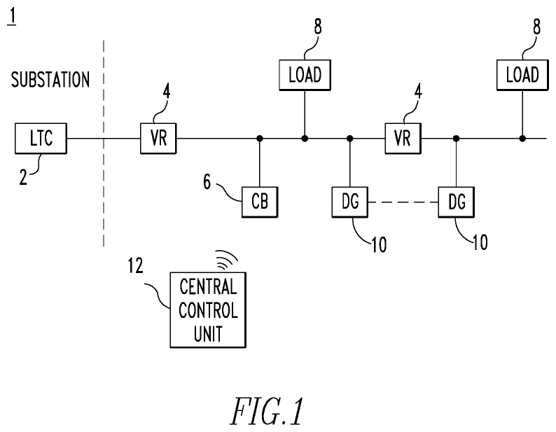

FIG. 1 is a schematic diagram of an electrical grid 1 in accordance with an example embodiment of the disclosed concept. The electrical grid 1 includes persistent power sources such as power plants (not shown). The electrical grid 1 also includes one or more DGs 10. Some of the DGs 10 may be renewable DGs such as photovoltaic power sources or wind power sources. Renewable DGs are usually intermittent power sources in that various conditions such as cloud cover or variable wind conditions, for example, can stop or lower the amount of power provided by the DG. Various loads 8 are also connected to the grid 1. The loads 8 may be residences, commercial buildings, or any other type of load using power from the grid.

The grid 1 includes various equipment to assist with voltage and VAR control. The equipment may be distributed throughout the grid. For example, the grid includes LTCs 2, VRs 4, and CBs 6 at various locations throughout the grid. LTCs 2 are tap-changing autotransformers designed to regulate voltage if it does not fall within preset limits. VRs 4 are also tap-changing autotransformers designed to regulate voltage. The LTCs 2 are typically located at a substation while the VRs 4 are typically located downstream of the substation. LTCs 2 and VRs 4 are generally designed to change positions a few times a day to regulate voltage with respect to variations in the loads 8 connected to the grid 1. The CBs 6 are reactive power compensators that can be found in both substation and distribution feeders. The CBs 6 can be switched on to provide reactive power.

The grid 1 also includes a centralized control unit 12. The centralized control unit 12 is capable of communicating with various elements of the grid via a wireless network or other type of connection. The centralized control unit 12 may receive information about the grid 1, such as voltages, power usage, or other characteristics at various points throughout the grid. The centralized control unit 12 may also communicate settings information or other types of information to various devices connected to the grid such as the DGs 10, LTCs 2, VRs 4, and CBs 6.

In example embodiments, the LTCs 2, VRs 4, and CBs 6 are controlled to regulate voltage and VAR on the grid. Additionally, the DGs 10 are used to provide reactive power. In an example embodiment of the disclosed concept, a layered approach to voltage and VAR control on the grid 1 is employed. In another example embodiment of the disclosed concept, a layered approach to operation of the grid 1 to provide resiliency and maximizing picked up loads is employed.

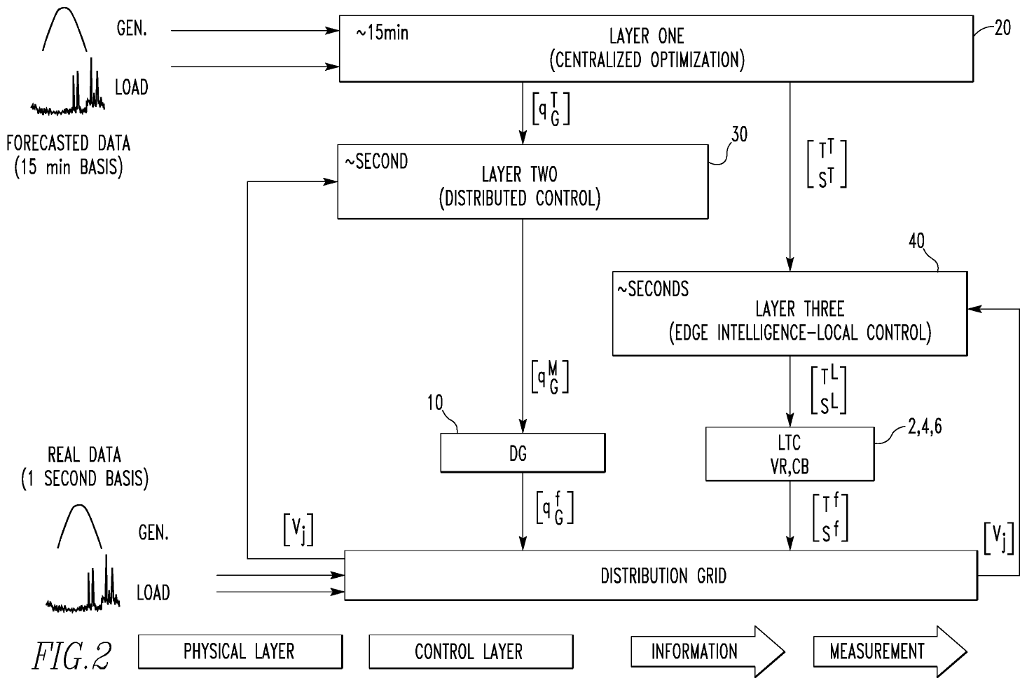

FIG. 2 is a conceptual diagram of a hierarchical layered approach to voltage and VAR control on a grid in accordance with an example embodiment of the disclosed concept. The layered approach conceptually illustrated in FIG. 2 may be employed to control the voltage and VAR on the grid 1 of FIG. 1.

In layer one 20, centralized optimization of the voltage and VAR of the grid 1 is performed. Control in layer one 20 may be performed by the centralized control unit 12. In layer one 20, the centralized control unit 12 receives forecasted load and generation data for the grid 1. For example, the forecasted data may look a day-ahead at 15-minute increments. However, it will be appreciated by those having ordinary skill in the art that the forecasted data may forecast any suitable period into the future at any suitable increment without departing from the scope of the disclosed concept.

Based on the forecasted data, the centralized control unit 12 calculates an optimized on/off status of CBs 6, tap operation of LTCs 2 and VRs 4, and reactive power provisioning from DGs 10 connected to the grid 1. This settings information for the CBs 6, LTCs 2, VRs 4, and DGs 10 may be calculated for each time increment of the forecasted data. However, it will be appreciated that the settings information may be calculated for different time periods without departing from the scope of the disclosed concept. The centralized control unit 12 communicates the setting information to layer two 30 and layer three 40. In more detail, the centralized control unit 12 communicates the settings information for the DGs 10 to layer two 30 and the settings information for the LTCs 2, VRs 4, and CBs 6 to layer three 40.

Layer two 30 provides distributed control of the DGs 10. Layer two 30 may be implemented in a distributed fashion in the DGs 10 or control units associated with the DGs 10. As noted above, layer two 30 receives power provisioning settings for the DGs 10 from layer one 20. In layer two 30, the DGs 10 begin with their power provisioning settings provided from layer one 20. However, in layer two 30, each DG 10 measures the voltage at its terminal. If the voltage is higher or lower than predetermined threshold voltages, the DG 10 requests for reactive power from its neighboring DGs 10. The DGs 10 are structured to communicate with each other via any suitable type of communication (e.g., without limitation, Wi-Fi, ZigBee, power line communication, etc.). Each DG 10 calculates its share of contribution to meet the requested reactive power via a distributed algorithm. Based on the results of the distributed algorithm, the DGs 10 control their amount of reactive power output.

Layer two 30 operates in real time. That is, the DGs 10 continuously monitor their output voltages and implement the distributed algorithm to calculate the share of contribution of each DG 10. The DG 10 provisioning settings are injected from layer one at layer one's predetermined interval (e.g., 15 minutes).

Layer three 40 provides local control. Layer three 40 may be implemented in the LTCs 2, VRs 4, and CBs 6. For example, the devices in layer three 40 autonomously control themselves to maintain their output voltages within a preset range. For example, if the output voltage of an LTC 2 is out of a predetermined voltage range for a predetermined period of time, the LTC 2 will autonomously adjust its tap position to bring its output voltage back within the predetermined voltage range. In the layer three 40 control, the LTCs 2, VRs 4, and CBs 6 update their settings at a faster rate (e.g., seconds), than the rate that the layer one 20 control generates the settings information.

Layer three 40 is also coordinated with layer one 20. As noted above, layer one 20 provides settings information for the LTCs 2, VRs 4, and CBs 6 based on forecasted data. In some example embodiments, the devices in layer three 40 will determine whether to control themselves based on the settings information received from layer one 20 or from their own autonomous local control based on the proximity in time to when the latest settings information was received. When the settings information is received and shortly thereafter, the devices of layer three 40 are most likely to control themselves based on the settings information. As time progresses from when the settings information was last received, the devices of layer three 40 are more likely to control themselves based on their own output voltage measurements. In this manner, the LTCs 2, VRs 4, and CBs 6 can provide adjustment in response to varying load and power generation fluctuations that deviate from the settings derived from the forecasted data used by layer one 20.

The hierarchical layered approach to controlling voltage and VAR on the grid 1 shown in the conceptual diagram of FIG. 2 provides improved voltage and VAR control. Layer one 20 provides centralized optimization. While layer one 20 provides optimal initial settings based on forecasted data, with only layer one 20 control, the grid 1 would be susceptible to voltage and VAR variation due to factors such as intermittent DGs 10 or variable loads 8. Layer two 30 provides distributed control of DGs 10, which allows real time adjustment of provisioning from DGs 10 based on a distributed algorithm. Layer three 40 provides local control of devices. With the addition of layers two 30 and three 40, the voltage and VAR on the grid 1 can be effectively controlled in light of changing conditions such as variable loads 8 and intermittent DGs 10. Additionally, layers two 30 and three 40 adjust settings at faster rates that layer one 20 generates settings information, thus allowing voltage deviations on the grid 1 to be addressed at multiple time scales.

In addition to providing improved control of voltage and VAR, the disclosed concept can also be applied to provide improved resilience of a distribution grid in the presence of outages. Resilience of a distribution grid with respect to disturbances is the property that characterizes its ability to withstand and recover from the particular class of disturbances by being allowed to temporarily transit to a state where its performance is significantly degraded and returning within acceptable time to a state where certain minimal, but critical, performance criteria are met.

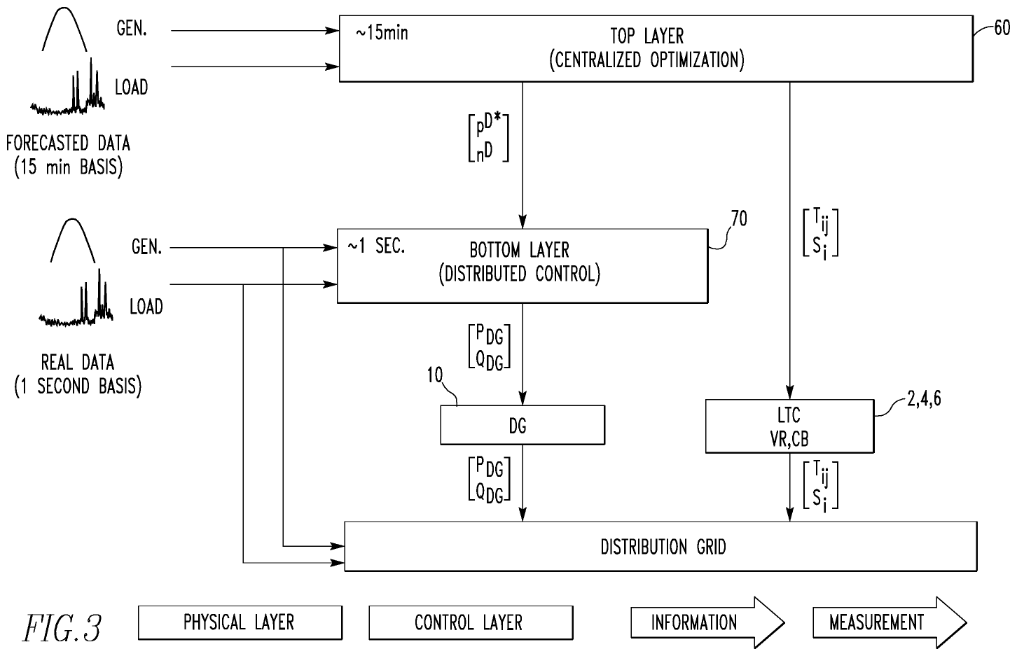

FIG. 3 is a conceptual diagram of a hierarchical layered approach to operation of a distribution grid which provides improved resilience in accordance with another example embodiment of the disclosed concept. The layered approach conceptually illustrated in FIG. 3 may be employed to operate the grid of FIG. 1.

The hierarchical layered approach in FIG. 3 includes a hierarchical layer structure similar to the layered approach of FIG. 2. However, the layered approach of FIG. 3 only includes a top layer 60 and a bottom layer 70, rather than three layers. In the approach of FIG. 3, the top layer 60 provides centralized optimization somewhat similar to layer one 20 in FIG. 2. However, the top layer 60 may use an algorithm to optimize by maximizing the out-of-service loads to be picked up. The loads may be weighted based on their criticality. For example, the top layer 60 calculates the on/off status of the CBs 6, the tap operation of the LTCs 2 and VRs 4, and the reactive power provisioning from the DGs 10 for the next 24 hours based on day-ahead 15 minute load and generation forecasted data. The settings may be optimized to maximize the out-of-service loads to be picked up. These settings will be communicated to the LTCs 2, VRs 4, CBs 6, and to the bottom layer 70. In this example embodiment, operation of the LTCs 2, VRs 4, and CBs 6 is specified by the top layer 60. That is, the LTCs 2, VRs 4, and CBs 6 do not have their own local autonomous control such as in the example embodiment of FIG. 2. However, it will be appreciated by those having ordinary skill in the art, that this example embodiment may be modified such that some or all of the LTCs 2, VRs 4, and CBs 6 have their own local autonomous control without departing from the scope of the disclosed concept.

The bottom layer 70 provides distributed control of the DGs 10 somewhat similar to layer two 30 of FIG. 3. For example, based on the settings received from the top layer 60, the DGs 10 measure their terminal voltages and determine the required active and reactive power for better voltage regulation. For example, if the terminal voltage of a DG 8 is higher or lower than predefined upper and lower threshold voltages, the DG 8 requests active or reactive power from its neighboring DGs 10 that have additional capacity. Each DG 8 calculates its share of contribution to meet the requested reactive power via a distributed algorithm via a communication network (e.g., Wi-Fi, ZigBee, power line communication, etc.) to exchange information among the neighboring DGs 10. Based on the consensus reached in the distributed algorithm, the DGs 10 adjust their active and reactive power provisioning. In some example embodiments, the adjustments to the power provisioning by the DGs 10 through the distributed algorithm in the bottom layer 70 occurs at a faster rate than power provisioning information is received from the top layer 60.

In summary, the top layer 60 provides an estimated active and reactive power of the DGs 10 as well as CB 6 switching and LTC 2 and VR 4 tap operation at a specified interval (e.g., every 15 minutes). The bottom layer 70 uses the information received from the top layer 60 as well as real-time values of loads to adjust active and reactive power generation of the DGs 10 at a faster rate (e.g., 1 second).

The example embodiment shown in FIG. 3 provides improved resiliency in operation of a distribution grid compared to methods of operation that only provide centralized optimization. For example and without limitation, the bottom layer 70 allows faster adjustment for unexpected or unpredictable events such as intermittent clouds passing over solar arrays. The intermittent clouds can cause solar DGs 10 to have reduced output such that the total load exceeds the total power generation, thus resulting in loads being dropped. If only centralized optimization is used, this intermittent drop in generation can cause normal loads and critical loads to be dropped for periods of time. However, with the addition of the bottom layer 70, the DGs 10 can react quickly and pick up critical loads significantly faster. For example, when the centralized optimization updates every 15 minutes, it could take up to 15 minutes to receive new power provisioning information and to pick up a critical load. On the other hand, with the hierarchical approach of FIG. 3, the bottom layer 70 may update at a faster rate (e.g., 1 second) and can pick up a critical load that was dropped due to a disturbance in just 1 second. Thus, the hierarchical approach to operation of a distribution grid shown in FIG. 3 provides significantly increased resiliency and maximizes load restoration during faults.

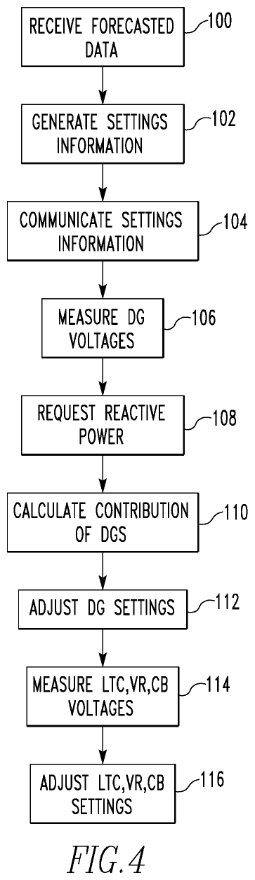

FIG. 4 is a flowchart of a method of controlling an electrical grid in accordance with an example embodiment of the disclosed concept. The method of FIG. 4 may be used, for example, to implement the hierarchical layered approach to grid control described with respect to the conceptual diagram of FIG. 2. The method may be implemented in the grid 1 of FIG. 1

The method begins at 100 where centralized control unit 12 receives forecasted load and generation data for the grid 1. At 102, the centralized control unit 12 generates settings information for the LTCs 2, VRs 4, CBs 6, and DGs 10 based on the forecasted data. At 104, the centralized control unit 12 communicates the settings information to the LTCs 2, VRs 4, CBs 6, and DGs 10. Steps 100-104 represent the layer one 20 control of FIG. 2.

At 106, the DGs 10 measure their respective output voltages. At 108, if any DGs 10 have voltages that fall outside a predetermined voltage range, they request reactive power from neighboring DGs 10. At 110, a distributed algorithm is used to calculate the contribution of each DG 10 to accommodate the requested reactive power. At 112, the DGs 10 adjust their settings to each provide their calculated contribution to the requested reactive power. Steps 106-112 represent the layer two 30 control of FIG. 2.

At 114, the LTCs 2, VRs 4, and CBs 6 measure their output voltages. At 116, the LTCs 2, VRs 4, and CBs 6 adjust their settings to maintain voltages within a predetermined range of voltages. The LTCs 2, VRs 4, and CBs 6 also determine whether to adjust their settings based on their own measured voltages or based on the settings information provided by the centralized control unit 12 based on the elapsed time since the latest settings information was received. Steps 114 and 116 represent the layer three 40 control of FIG. 2.

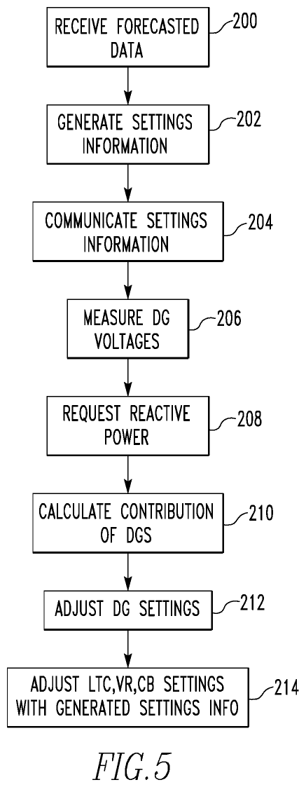

FIG. 5 is a flowchart of a method of controlling an electrical grid in accordance with another example embodiment of the disclosed concept. The method of FIG. 5 may be used, for example, to implement the hierarchical layered approach to grid control described with respect to the conceptual diagram of FIG. 3. The method may be implemented in the grid 1 of FIG. 1

The method begins at 200 where centralized control unit 12 receives forecasted load and generation data for the grid 1. At 202, the centralized control unit 12 generates settings information for the LTCs 2, VRs 4, CBs 6, and DGs 10 based on the forecasted data. At 104, the centralized control unit 12 communicates the settings information to the LTCs 2, VRs 4, CBs 6, and DGs 10. Steps 200-204 represent the top layer 60 control of FIG. 3.

At 206, the DGs 10 measure their respective output voltages. At 208, if any DGs 10 have voltages that fall outside a predetermined voltage range, they request reactive power from neighboring DGs 10. At 210, a distributed algorithm is used to calculate the contribution of each DG 10 to accommodate the requested reactive power. At 212, the DGs 10 adjust their settings to each provide their calculated contribution to the requested reactive power. Steps 206-212 represent the bottom layer 70 control of FIG. 3. At 214, the LTCs 2, VRs 4, and CBs 6 adjust their settings based on the settings information provided from the centralized control unit 12.

One or more aspects of the disclosed concept can also be embodied as computer readable codes on a tangible, non-transitory computer readable recording medium. The computer readable recording medium is any data storage device that can store data which can be thereafter read by a computer system. Non-limiting examples of the computer readable recording medium include read-only memory (ROM), non-volatile random-access memory (RAM), CD-ROMs, magnetic tapes, floppy disks, disk storage devices, and optical data storage devices.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

1. An electrical grid control system comprising:
a number of load tap changers;
a number of voltage regulators;
a number of capacitor banks;
a number of distributed generators; and
a centralized control unit structured to generate settings information for the load tap changers, the voltage regulators, the capacitor banks, and the distributed generators based on forecasted data,
wherein the distributed generators are structured to use the settings information and a distributed algorithm to control power provisioning from each of the distributed generators, and
wherein the load tap changers, the voltage regulators, and the capacitor banks are structured to adjust their settings based on the settings information and local voltage measurements.

2. The electrical grid control system of claim 1, wherein the centralized control unit is structured to generate the settings information at predetermined intervals.

3. The electrical grid control system of claim 1, wherein each distributed generator is structured to monitor its voltage and to request reactive power from neighboring distributed generators when its voltage is outside a predetermined voltage range.

4. The electrical grid control system of claim 3, wherein the distributed generators are structured to use the distributed algorithm to determine a contribution of power provisioning from each of the distributed generators and to control power provisioning from each of the distributed generators based on the determined contributions.

5. The electrical grid control system of claim 1, wherein the distributed generators are structured to continuously use the distributed algorithm to control power provisioning from each of the distributed generators.

6. The electrical grid control system of claim 1, wherein the load tap changers, the voltage regulators, and the capacitor banks are structured to adjust their settings to maintain output voltages within a predetermined voltage range.

7. The electrical grid control system of claim 1, wherein load tap changers, the voltage regulators, and the capacitor banks are structured to determine whether to adjust their settings based on the settings information or based on the local voltage measurements based on an elapsed time since the settings information was received.

8. A method of controlling an electrical grid, the method comprising:
generating settings information for load tap changers, voltage regulators, capacitor banks, and distributed generators based on forecasted data;
adjusting power provisioning of the distributed generators based on the settings information and a distributed algorithm; and
adjusting settings of the load tap changes, voltage regulators, and capacitor banks based on the settings information and local voltage measurements.

9. The method of claim 8, wherein the settings information is generated at predetermined intervals.

10. The method of claim 8, wherein adjusting power provisioning of the distributed generators comprises monitoring voltages of each distributed generator and requesting reactive power from neighboring distributed generators when the monitored voltage a selected distributed generator is outside a predetermined voltage range.

11. The method of claim 10, wherein adjusting power provisioning of the distributed generators further comprises using the distributed algorithm to determine a contribution of power provisioning from each of the distributed generators and controlling power provisioning from each of the distributed generators based on the determined contributions.

12. The method of claim 8, wherein adjusting power provisioning of the distributed generators comprises continuously using the distributed algorithm to control power provisioning from each of the distributed generators.

13. The method of claim 8, wherein adjusting settings of the load tap changers, voltage regulators, and capacitor banks comprises adjusting the settings of the load tap changers, the voltage regulators, and the capacitor banks to maintain output voltages within a predetermined voltage range.

14. An electrical grid control system comprising:
a number of load tap changers;
a number of voltage regulators;
a number of capacitor banks;
a number of distributed generators; and
a centralized control unit structured to generate settings information for the load tap changers, the voltage regulators, the capacitor banks, and the distributed generators based on forecasted data,
wherein the centralized control unit is structured to control settings of the load tap changers, the voltage regulators, and the capacitor banks based on the generated settings information, and
wherein the distributed generators are structured to use the settings information and a distributed algorithm to control power provisioning from each of the distributed generators.

15. A method of controlling an electrical grid, the method comprising:
generating settings information for load tap changers, voltage regulators, capacitor banks, and distributed generators based on forecasted data;
adjusting power provisioning of the distributed generators based on the settings information and a distributed algorithm; and
adjusting settings of the load tap changes, voltage regulators, and capacitor banks based on the settings information.
